(19) United States
(12) Patent Application Publication
(10) Pub. No.: US 2015/0019518 A1
(43) Pub. Date: Jan. 15, 2015

(54) Greeting Card with Identifier for Accessing Electronic Version of Image Depicted on Card, System and Method

(71) Applicant: James Matthew Buchanan, Perrysburg, OH (US)

(72) Inventor: James Matthew Buchanan, Perrysburg, OH (US)

(21) Appl. No.: 14/325,653

(22) Filed: Jul. 8, 2014

Related U.S. Application Data
(60) Provisional application No. 61/844,072, filed on Jul. 9, 2013.

(51) Int. Cl. B42D 15/02; G06F 17/30; B42D 15/04

(52) U.S. Cl. CPC B42D 15/027; B42D 15/025; B42D 15/042; G06F 17/30244
USPC 707/705; 40/124.01; 40/124.09

(57) ABSTRACT

Image-bearing tangible items, pluralities of image-bearing tangible items, systems for granting access to electronic versions of an image associated with a tangible item, and methods for granting access to electronic versions of an image associated with a tangible item are described. Example embodiments relate to greeting cards, systems and methods.

### FIELD

The disclosure relates generally to image-bearing tangible items, systems and methods.

### BRIEF SUMMARY OF SELECTED EMBODIMENTS

The disclosure relates generally to image-bearing tangible items, systems and methods. Embodiments relate to greeting cards, systems and methods.

In an example embodiment, each greeting card of a plurality of greeting cards comprises a substrate; an image associated with the substrate; and an identifier associated with the substrate. The identifier represents a key in a data record of a remote data store that can be submitted by a holder of the greeting card to a computer system adapted to retrieve information relating to an electronic version of the image from the data store and transmit the information to the holder of the greeting card. In this example embodiment, each greeting card of the plurality of greeting cards has the same image associated with the substrate.

In an example embodiment, a greeting card system comprises a plurality of greeting cards, each greeting card of the plurality of greeting cards comprising a substrate, a common image associated with the substrate, and an identifier associated with the substrate; a data store containing information about the common image; and a computer adapted to retrieve the information from the data store using an identifier associated with the substrate of a greeting card of the plurality of greeting cards and adapted to present electronic versions of the image to a holder of the greeting card.

In an example embodiment, a method of granting access to electronic versions of an image comprises selecting an image for association with a plurality of greeting cards; producing a plurality of greeting cards, each greeting card of the plurality of greeting cards comprising a substrate having the image associated with the substrate and an identifier associated with the substrate; transferring the plurality of greeting cards to a retailer; accepting an identifier associated with the substrate of a greeting card of the plurality of greeting cards from a user who received the greeting card from the retailer; retrieving information relating to the common image from a data store based on the identifier; and presenting one or more electronic versions of the common image to the user for the user's personal use.

### BRIEF DESCRIPTION OF THE DRAWINGS

FIG. 1A is a front perspective view of a greeting card.

FIG. 1B is a rear perspective view of the greeting card illustrated in FIG. 1A.

FIG. 1C is a rear perspective view of the greeting card illustrated in FIG. 1A with an alternative second portion of a first side.

FIG. 2A is a front view of another greeting card.

FIG. 2B is a read view of the greeting card illustrated in FIG. 2A.

FIG. 3A is a front view of a keycard.

FIG. 3B is a rear view of the keycard illustrated in FIG. 3A.

FIG. 4 is a schematic illustration of a system for granting access to electronic versions of an image associated with a tangible item.

FIG. 5 is a flowchart illustration of a method for granting access to electronic versions of an image associated with a tangible item.

FIG. 6 is a schematic illustration of a plurality of greeting cards.

FIG. 7 is a flowchart illustration of a method for granting access to electronic versions of an image associated with a tangible item.

FIG. 8 is a flowchart illustration of a method for granting access to electronic versions of an image associated with a tangible item.

FIG. 9 is a flowchart illustration of a method for granting access to electronic versions of an image associated with a tangible item.

FIG. 10 is a flowchart illustration of a method for granting access to electronic versions of an image associated with a tangible item.

FIG. 11 is a flowchart illustration of a method for granting access to electronic versions of an image associated with a tangible item.

### DETAILED DESCRIPTION

The following detailed description and the appended drawings provide examples of various embodiments and are provided to enable one skilled in the art to make, use and/or practice one or more example embodiments. Neither the description nor the illustration of any example embodiment is intended to limit the scope of any claim in any manner.

As used herein, the term “holder” refers to a person having a referenced tangible item in his or her control. It does not require actual, physical contact with the tangible item.

As used herein, the term “user” refers to a holder of a tangible item who is using the tangible item.

As used herein, the term “obscured” refers to the property of an identifier associated with a tangible item not being visible to a holder of the tangible item to a degree that the holder of the tangible item cannot discern individual elements in the identifier.

Various tangible items can be made as embodiments. A tangible item made as an embodiment has a substrate, an image associated with the substrate, and at least one identifier associated with the substrate. The tangible item for a particular embodiment can comprise any tangible item capable of having the elements as described. Examples of tangible items that can be made as embodiments include greeting cards; keycards; financial cards; business cards; promotional cards; promotional flyers; calendars; containers for holding liquids, such as glasses, cups, and mugs; picture frames; magnets; and edible items.

In any tangible item made as an embodiment, the substrate can comprise any suitable substrate capable of having the image and identifier or identifiers associated with it. Examples of substrates currently considered suitable include paper; card stock; ceramic; metal, such as stainless steel, titanium, nickel, chrome, and brass; wood; plastic; glass; rubber; sand; and edible compositions. Also in any embodiment, the substrate can have any suitable size, shape and configuration. A skilled artisan will be able to select a suitable substrate and a suitable size, shape and configuration for a selected substrate in a tangible item according to a particular embodiment based on various considerations, including the manner in which the user or users of the tangible item will interact with or otherwise use the tangible item.

In any tangible item made as an embodiment, the image can comprise any suitable type of image that can be represented in both physical and electronic versions, including a photograph, a drawing, a sketch, a plan, a map, a diagram, a logo, a design, or any other suitable type of image. Also, the image can be associated with the substrate in any suitable manner. A skilled artisan will be able to select a suitable manner in which an image is associated with a substrate in a tangible item according to a particular embodiment based on various considerations, including the nature of the substrate. Examples of manners in which an image can be associated with a substrate that are currently considered suitable include being disposed on the substrate, such as being printed onto the substrate; attached to the substrate, such as with an adhesive; and being formed by the substrate, such as being carved, cut or etched into our out of the substrate.

In any tangible item made as an embodiment, an identifier can comprise any suitable identifier that can be used by a holder of the tangible item to access one or more electronic versions of the image with a computer system. For example, an identifier can comprise a string of letters, numbers, and/or symbols that can be input into a computer system using a keyboard. In these embodiments, the identifier can be submitted by a holder of the tangible item to a computer system to obtain an electronic version of the image. For example, an identifier can comprise a key in a data record that contains information about the image, such as a data record in a data store. When the identifier is submitted to the computer system by a holder of the tangible item, either directly or over a network, the computer system can retrieve the data record using the identifier as a key in an appropriate query. Using the results of the query, the computer system can present one or more electronic versions of the image to the holder of the tangible item, such as through a web browser. In these embodiments, the identifier can comprise a key in a data record in a database local to the computer system, a key in a data record in a database remote to the computer system, a key in a file-based data store local to the computer system, or a key in a file-based data store remote to the computer system. Alternatively, an identifier can be translated into a key in a data record that contains information about the image by a computer system. In these embodiments, the identifier can be submitted by a holder of the tangible item to a computer system that has a processor and software adapted to translate the identifier into a key in a data record that contains information about the image, such as a data record in a data store, to obtain an electronic version of the image

Alternatively, an identifier can comprise a symbol that can be interpreted by a device operated by a holder of the tangible item to access one or more electronic versions of the image with the device or a separate computer system. For example, an identifier can comprise a barcode symbol that can be interpreted by a barcode scanner operated by a holder of the tangible item and subsequently used by a computer system connected to the barcode scanner to obtain an electronic version of the image. Alternatively, an identifier can comprise a barcode symbol that can be interpreted by a computer system, such as a mobile phone, tablet computer, or other handheld computer, operated by a holder of the tangible item and subsequently used by the computer system to obtain an electronic version of the image. In embodiments in which the identifier comprises a symbol, the symbol can encode any information that can be used directly or indirectly, to access one or more electronic versions of the image with a computer system. For example, a symbol can encode a string of letters, numbers, and/or symbols that can be input into a computer system using a keyboard, such as the identifiers described above. Also as an example, a symbol can encode a Uniform Resource Locator (URL) that, when opened in a web browser, presents one or more electronic versions of the image to the viewer. Examples of suitable types of symbol identifiers include barcodes, QR codes, and the like.

In some embodiments, an identifier is unique across all tangible items with which a particular image is associated. In some embodiments, an identifier is not unique across all tangible items with which a particular image is associated. In some embodiments, the same identifier is included in all tangible items with which a particular image is associated. In some embodiments that include multiple identifiers, each identifier associated with the tangible item is unique across all identifiers associated with the tangible item. In some embodiments that include multiple identifiers, some identifiers associated with the tangible item are identical and at least one identifier associated with the tangible item is unique. In some embodiments that include multiple identifiers, all identifiers associated with the tangible item are the same. In some embodiments that include multiple identifiers, both identifiers are unique across all tangible items with which a particular image is associated. In some embodiments that include multiple identifiers, one identifier is unique across all tangible items with which a particular image is associated and another identifier is not unique across all tangible items with which a particular image is associated. In some embodiments that include multiple identifiers, none of the identifiers are unique across all tangible items with which a particular image is associated.

In any tangible item made as an embodiment, an identifier can be obscured. In these embodiments, the identifier can be obscured in any suitable manner, including disposition of an additional element on the substrate with which the identifier is associated and over the identifier. For example, the removable covering can be disposed on the substrate with which the identifier is associated and over the identifier. In these embodiments, the covering can comprises any covering that can be removed from the substrate to change the identifier from being obscured to being visible to a holder of the tangible item to a degree that the holder of the tangible item can discern individual elements in the identifier. Examples of suitable removable coverings include scratch-off coatings, such as those used in scratch-off amusement tickets and removable by scratching the coating with the edge of a coin, fingernail or other item; and labels, such as adhesive labels and cling labels that can be removed simply by lifting an edge of the label away from the substrate and pulling the edge until the entire label separates from the substrate.

### Illustrated Example Embodiments

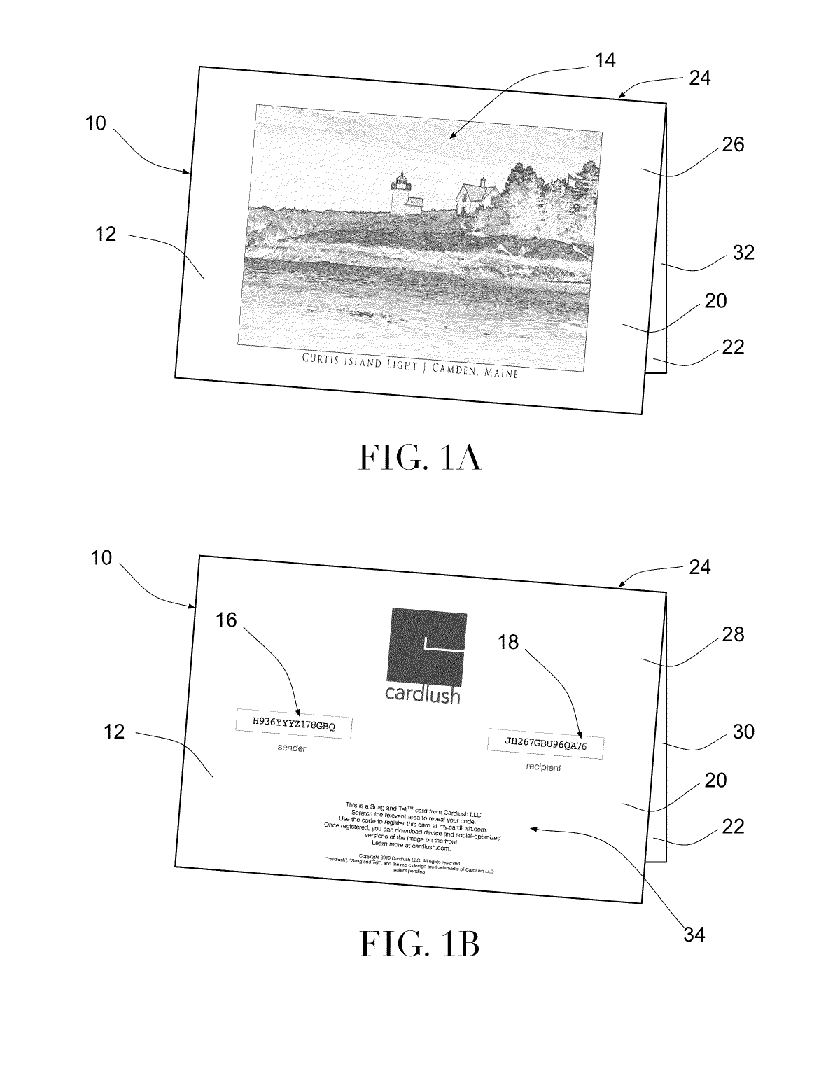

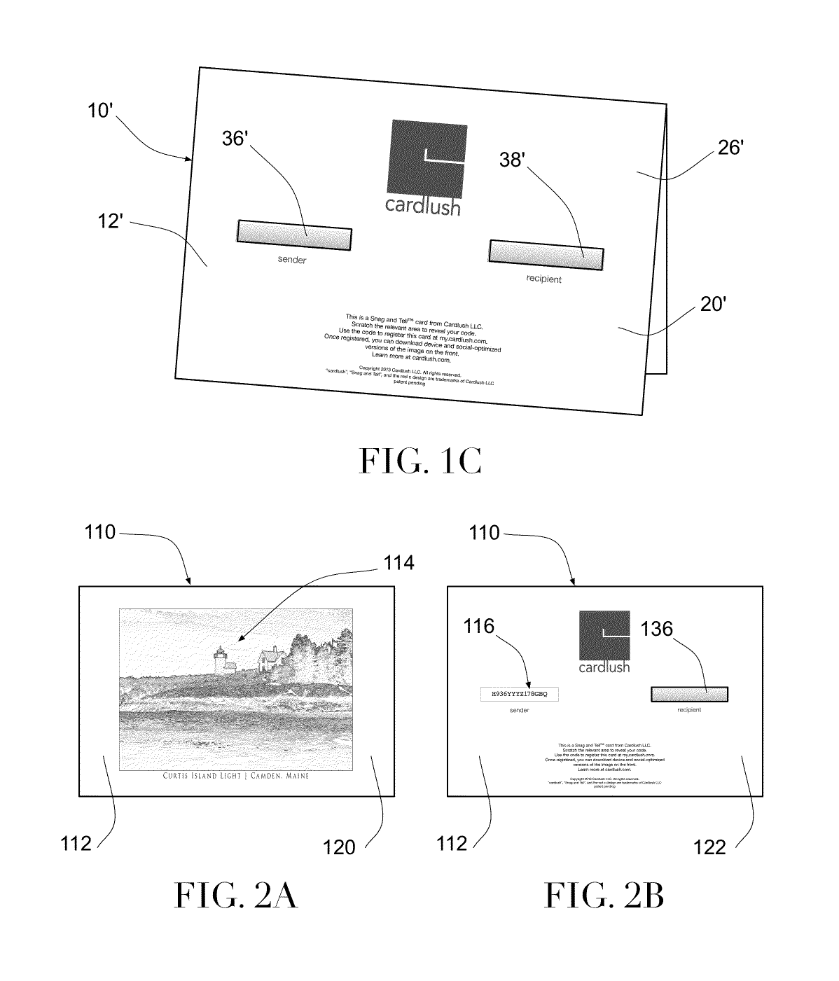

FIGS. 1A and 1B illustrate a greeting card 10 as an example of a tangible item made as an embodiment. The greeting card 10 has a substrate 12, an image 14 associated with the substrate 12, a first identifier 16 associated with the substrate 12, and a second identifier 18 associated with the substrate 12.

In the illustrated embodiment, each of the first 16 and second 18 identifiers represents a key in a data record of a remote data store that can be submitted by a holder of the greeting card 10 to a computer system to obtain an electronic version of the image 14. As such, the greeting card 10 provides a tangible item that can be used by a sender of the tangible item to obtain an electronic version of the image 14 for his or her use and to enable a chosen recipient to obtain an electronic version of the image 14 for his or her use.

In the illustrated embodiment, the substrate 12 comprises card stock, such as conventional card stock used in the making of conventional greeting cards.

In the illustrated embodiment, the substrate 12 comprises first 20 and second 22 sides. The substrate comprises a fold 24 that separates the first side 20 into first 26 and second 28 portions and that separates the second side 22 into third 30 and fourth 32 portions. In the illustrated embodiment, the image 14, the first identifier 16 and the second identifier 18 are associated with the first side 20. The image 14 is associated with the first portion 26 and the first 16 and second 18 identifiers are associated in the second 28 portion. In tangible items according to other embodiments, the image and the at least one identifier can be associated with any side and any portion of the substrate. Furthermore, the image and the at least one identifier can be associated with the same or different sides and portions of the substrate. Indeed, in tangible items that include two or more identifiers, the identifiers can be associated with the same or different sides of the substrate and the same or different portions of the substrate.

In the illustrated embodiment, the image 14 comprises a photograph, shown in the drawing as an outline of edges for illustration purposes.

In the illustrated embodiment, each of the identifiers 16, 18 comprises a string of alphanumeric characters. Also, each of the identifiers 16, 18 associated with the greeting card 10 is unique across all identifiers associated with the greeting card 10. Thus, the first identifier 16 is a different string of alphanumeric characters than the string of alphanumeric characters that constitute the second identifier 18.

In the illustrated embodiment, textual information 34, such as legal and/or marketing copy, is associated with the second portion 28.

FIG. 1C illustrates a second portion 28′ of a first side 20′ of an alternative greeting card 10′. In this alternative embodiment, each of the identifiers is obscured. While not visible in the Figure, the identifiers are associated with the substrate 12′ in the same manner as in the greeting card 10 illustrated in FIGS. 1A and 1B. In this alternative embodiment, a first removable covering 36′ is disposed on the substrate 12′ and over the first identifier. Similarly, a second removable covering 38′ is disposed on the substrate 12′ and over the second identifier. In the illustrated embodiment, each of the first removable covering 36′ and the second removable covering 38′ comprises a scratch-off coating.

The greeting card 10 illustrated in FIGS. 1A and 1B can be useful when it is desirable to offer a tangible item made as an embodiment for sale in an environment in which the portion of the substrate with which the identifiers 16, 18 is associated is not visible to potential purchasers prior to purchasing the tangible item. The alternative greeting card 10′ illustrated in FIG. 1C can be useful when it is desirable to offer a tangible item made as an embodiment for sale in an environment in which the portion of the substrate with which the identifiers is associated is visible to potential purchasers prior to purchasing the tangible item. After purchasing the alternative greeting card 10′, the purchaser, now a holder of the greeting card 10′, can remove one or both of the first 36′ and second 38′ removable coverings and proceed to use the greeting card 10′.

FIGS. 2A and 2B illustrate another greeting card 110 as an example of a tangible item made as an embodiment. The greeting card 110 has a substrate 112, an image 114 associated with the substrate 112, a first identifier 116 associated with the substrate 112, and a second identifier associated with the substrate 112. While not visible in the Figures, the second identifier is associated with the substrate 112. In the illustrated embodiment, a removable covering 136 is disposed on the substrate 112 and over the second identifier. In the illustrated embodiment, the removable covering 136 comprises an adhesive label capable of being removed from the substrate 112 without damaging the substrate 112.

In this embodiment, the substrate 112 comprises first 120 and second 122 opposing sides. Unlike the greeting card 10 illustrated in FIGS. 1A and 1B, the substrate 112 in greeting card 110 lacks a fold. The image 114 is associated with the first side 120 of the substrate 112. The first 116 and second identifiers, and the removable covering 134, are associated with the second side 122 of the substrate. This configuration facilitates use of the greeting card 110 with or without an outer carrier, such as an envelope.

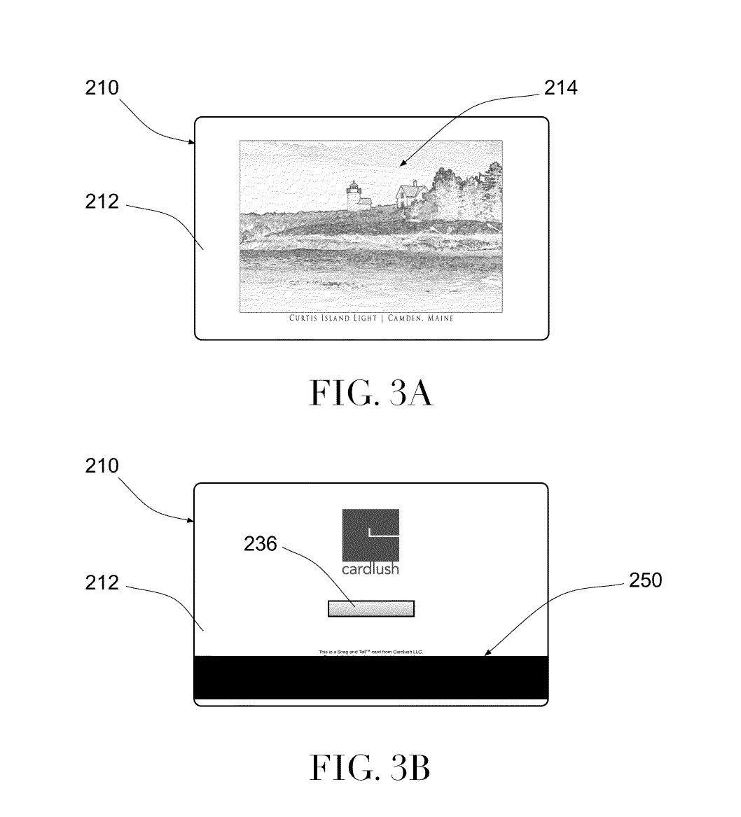

FIGS. 3A and 3B illustrate a keycard 210 as an example of a tangible item made as an embodiment. The keycard 210 has a substrate 212, an image 214 associated with the substrate 212, and an identifier associated with the substrate 212. As such, the keycard 210 is an example embodiment that includes only a single identifier. It is noted that a greeting card, as well as any other tangible item according to a particular embodiment, can be made in accordance with this embodiment in that the tangible item includes only a single identifier. While not visible in FIGS. 3A and 3B, the identifier is printed directly on the substrate 212. A removable covering 236 is disposed on the substrate 212 and over the identifier such that the identifier is deposed beneath the removable covering 236. In the illustrated embodiment, the removable covering 236 comprises a two-part adhesive label that includes a backing adhered to the substrate 212 and a scratch-off coating disposed on the backing. This configuration facilitates use of the keycard 210 in an environment where a holder of the keycard or of a plurality of keycards, such as an innkeeper, can decide if inclusion of removable covering 236 is desirable for an individual keycard or for each keycard of a plurality of keycards.

In this embodiment, a magnetic strip 250 is associated with the substrate 212. If included in a tangible item according to an embodiment, the magnetic strip can encode information, such as financial account information, such as on a card used in financial transactions, information to unlock a lock, or any other suitable information. In the illustrated embodiment, the magnetic strip 250 encodes information to unlock a lock securing a door, making the keycard useful for unlocking an appropriately coded lock securing a door. For example, the magnetic strip 250 can encode information to unlock a lock securing a door to a temporary residence, such as a hotel room.

The magnetic strip 250 is an example of suitable structure that can be included in a tangible item made as an embodiment to encode information. Other examples of suitable structure that can be included in a tangible item made as an embodiment include an integrated circuit and a Radio Frequency Identification (RFID) chip or tag. Tangible items made as embodiments that include an integrated circuit for encoding information can comprise a smart card.

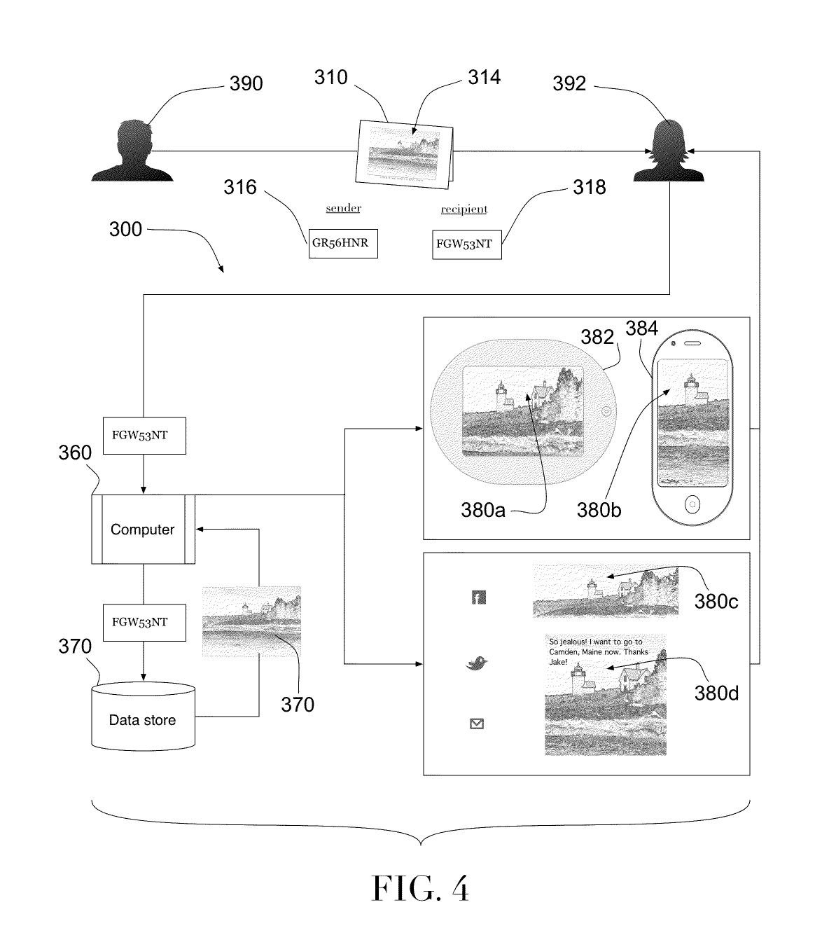

FIG. 4 is a schematic illustration of a system 300 for granting access to electronic versions of an image associated with a tangible item. In the illustrated embodiment, system 300 includes a tangible item 310 with which an image 314 is associated. First 316 and second 318 identifiers are also associated with the tangible item 310. The system also includes a computer 360 having a processor and suitable software for connecting to a data store 370 and for presenting electronic versions 380a, 380b, 380c, 380d of the image 314 to a user, such as a recipient 392 who received the tangible item 310 from a sender 390.

In the illustrated embodiment, the tangible item 310 is a greeting card similar to greeting card 10 illustrated in FIGS. 1A and 1B and described above. It is noted, though, that the tangible item 310 can comprise any tangible item according to an embodiment. One or both of the identifiers 316, 318 can be obscured if desired.

The computer 360 can comprise any suitable computer adapted to retrieve information about the image 314 from the data store 370 and to present electronic versions of the image 314 to a user. For example, a suitable computer can be adapted to access the data store 370 using one or both of the identifiers 316, 318, or another identifier based on one or both of the identifiers 316, 318, to retrieve information about the image 314 that has been stored in the data store 370. Also, a suitable computer can be adapted to present electronic versions of the image 314 by sending an electronic mail message to the user, by serving a web page to the user, or in another suitable manner. The computer 360 can include the data store 370 or can be operably connected to the data store 370, either directly or via a network, such as the Internet. For example, a single computer can include the data store as a local database and can operate a web server for presenting electronic versions of the image 314 to a user. Alternatively, a series of computers can be used. For example, one computer can accept an identifier 318 from the user 392 and prepare and submit a request to another computer that controls the data store 370. The data store 370 computer can return the information to the first computer for presenting electronic versions of the image 314 to the user 392, or can send the information to another connected computer for presenting electronic versions of the image 314 to the user 392. Thus, the computer 360 can be a single computer, or two or more operably connected computers.

Also, a master electronic version 380 of the image 314 can be stored on the computer 360 or on a computer operably connected to the computer 360. The computer 360 can use the master electronic version 380 to prepare one or more of the electronic versions 380a, 380b, 380c, 380d for presentation to the user 392. Alternatively, or additionally, one or more of the electronic versions 380a, 380b, 380c, 380d can be “pre-made” and stored on the computer 360 or on a computer operably connected to the computer 360.

The computer 360, or group of connected computers, can present one or more electronic versions of the image 314 to the user 392. When multiple electronic versions of the image 314 are presented to the user 392, the electronic versions can be identical to each other, or can be different electronic versions of the image 314. For example, the computer 360 can present multiple cropped versions of the image 314 to the user. In the illustrated embodiment, the computer 360 presents two electronic versions 380a, 380d of the image, each of which has been cropped to dimensions suitable for display on an electronic device. For example, electronic version 380a is a cropped version of the image 314 having dimensions suitable for display on tablet computer 382, while electronic version 380b is a cropped version of the image 314 having dimensions suitable for display on mobile telephone 384. Also in the illustrated embodiment, the computer 360 presents two electronic versions 380c, 380d of the image 314, each of which has been cropped to dimensions suitable for uploading to a social networking website. For example, electronic version 380c is a cropped version of the image 314 having dimensions suitable for uploading to the social network Facebook, operated at facebook.com, for use as a “Timeline Cover Image” by the user 392, while electronic version 380d is a cropped version of the image 314 having dimensions suitable for uploading to the social network Facebook as a “Timeline Shared Image” by the user 392. Other examples of electronic versions that can be prepared include an electronic version cropped to dimensions suitable for use as a profile image on a suitable social networking website, a version cropped to dimensions suitable for use as a background image on a suitable social networking website, and other electronic versions suitable for sharing on the Internet. The computer 360 can also present information about the electronic version or electronic versions of the image to the user, in addition to or in lieu of presenting the actual electronic versions of the image to the user.

The computer 360 can also present the user 392 with a License Agreement that grants to the user 392 upon acceptance rights to use one or more of the electronic versions of the image 314 that it presents to the user 392.

The computer 360 can also accept input from the user 392 that can be used by the computer 360 in a variety of manners. For example, the computer 360 can accept textual input from the user 392 that can be added to one or more of the electronic versions of the image 314. In this example, the user can submit text that may make the one or more electronic versions of the image 314 more desirable for sharing on one or more social networking websites, via e-mail or the like. As another example, a user 314 can upload an image or provide access to an image that the computer 360 can combine with the image 314 in the preparation of the one or more electronic versions of the image. For example, the user can upload his or her profile image for a particular social networking website and the computer 360 can combine the profile image with the image 314 in preparation of the one or more electronic versions.

The computer 360 can also present the user 392 with e-commerce options, such as an opportunity to purchase one or more tangible items with which the image 314 is also associated. For example, the computer 360 can present the user 392 with an e-commerce opportunity to purchase a physical print of the image 314, such as a framed print of the image 314. In one example embodiment, the computer 360, which can comprise a single computer or two or more computers operably connected to each other directly or via a network, includes software suitable for tracking revenue-earning parties related to a transaction in which the user 392 purchases another tangible item with which the image 314 is also associated. Examples of revenue-earning parties include, but are not limited to, a retailer who sold the original tangible item 310 to user 390, an artist who created the image 314, a brand-owner who provided the tangible item 310 to the user 392, a charity who has provided the tangible item 310 to the user 392, a previous holder of the tangible item 310, such as user 390, another party involved in the presentation of the tangible item 310 to the user 392, or any other party.

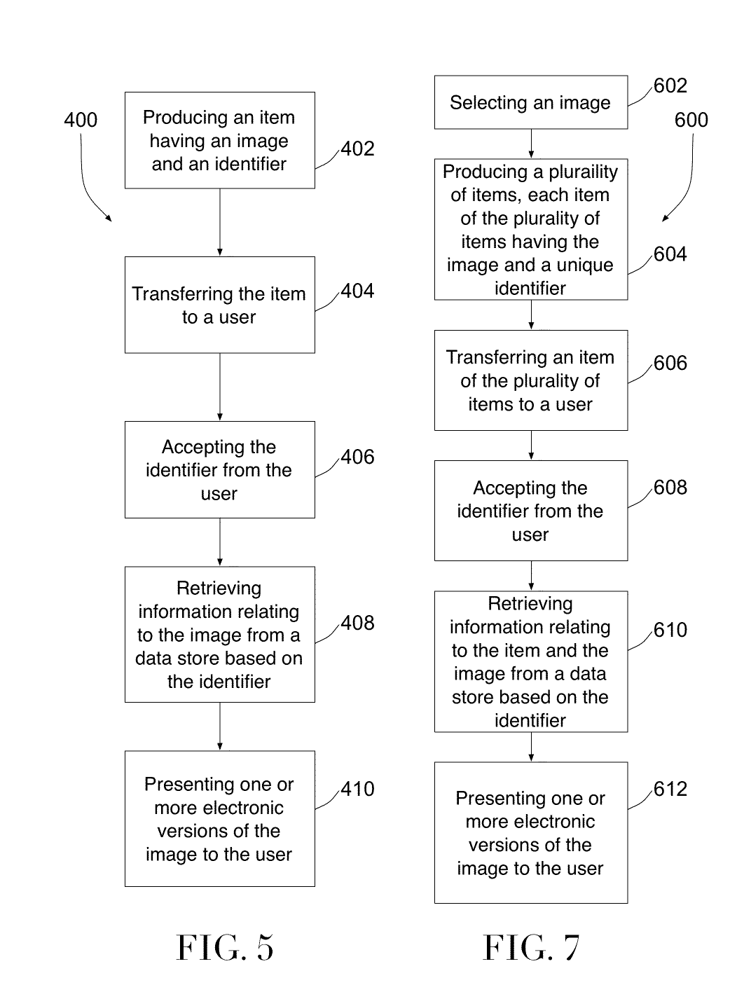

FIG. 5 is a flowchart illustration of a method 400 for granting access to electronic versions of an image associated with a tangible item. A first step 402 comprises producing a tangible item having an image associated with it and an identifier associated with it. A performer of the method 400 can perform this step by producing any tangible item made as an embodiment, including the various embodiments described and illustrated herein. Also, a performer of the method can perform this step by instructing another party to produce the tangible item made as an embodiment, such as in a contract production or contract manufacturing arrangement.

A second step 404 comprises transferring the tangible item to a user, who becomes a holder of the tangible item. A performer of the method 400 can perform this step in any suitable manner of transferring a tangible item from the performer to a user, such as by physically handing the tangible item to the user, by giving the tangible item to the user as a gift, by selling the tangible item to the user, and by any other manner. Furthermore, a performer can perform this step by transferring the tangible item to one or more intervening holders of the tangible item, who ultimately transfers the tangible item to the user. For example, a performer of the method can transfer the tangible item to a retailer, such as by selling the tangible item at a wholesale cost or on consignment terms, who ultimately transfers the tangible item to the user.

A third step 406 comprises accepting the identifier from the user. A performer of the method 400 can perform this step in any suitable manner of accepting an identifier from a user, such as by accepting a tangible item that includes the identifier from the user, accepting a report of the identifier from the user, such as an oral report over a telephone connection or internet audio connection, or accepting textual or other input representing the identifier from the user, such as via a computer form. In some embodiments, a performer operates a computer component of a system according to an embodiment that includes software adapted to accept textual input representing the identifier from the user via a form served by the computer or a connected computer by software configured to serve a web page that contains the form, such as Apache or NGINX web server software.

A fourth step 408 comprises retrieving information relating to the image from a data store based on the identifier accepted from the user in step 406. A performer of the method 400 can perform this step in any suitable manner, such as by preparing and submitting a query to database server software configured to retrieve the information from the data store. In some embodiments, a performer operates a computer component of a system according to an embodiment that includes software adapted to transform textual input representing the identifier, such as textual input accepted in step 406, into an appropriate query.

A fifth step 410 comprises presenting one or more electronic versions of the image to the user. A performer of the method 400 can perform this step in any suitable manner, such as by presenting an electronic storage device, such as a solid state memory drive, on which the electronic versions of the image have been stored, to the user. In some embodiments, a performer operates a computer component of a system according to an embodiment that includes software adapted to prepare one or more web pages based on the information retrieved in step 408 and that includes software adapted to serve the one or more web pages to the user. In some embodiments, the one or more web pages include one or more links that can be clicked by the user with a conventional mouse to initiate downloads of the one or more electronic versions of the image. In other embodiments, the one or more web pages include one or more buttons that can be clicked by the user with a conventional mouse to initiate a transfer of the one or more electronic versions of the image to a particular social networking website via an action adapted to interact with an application programming interface of the social networking website.

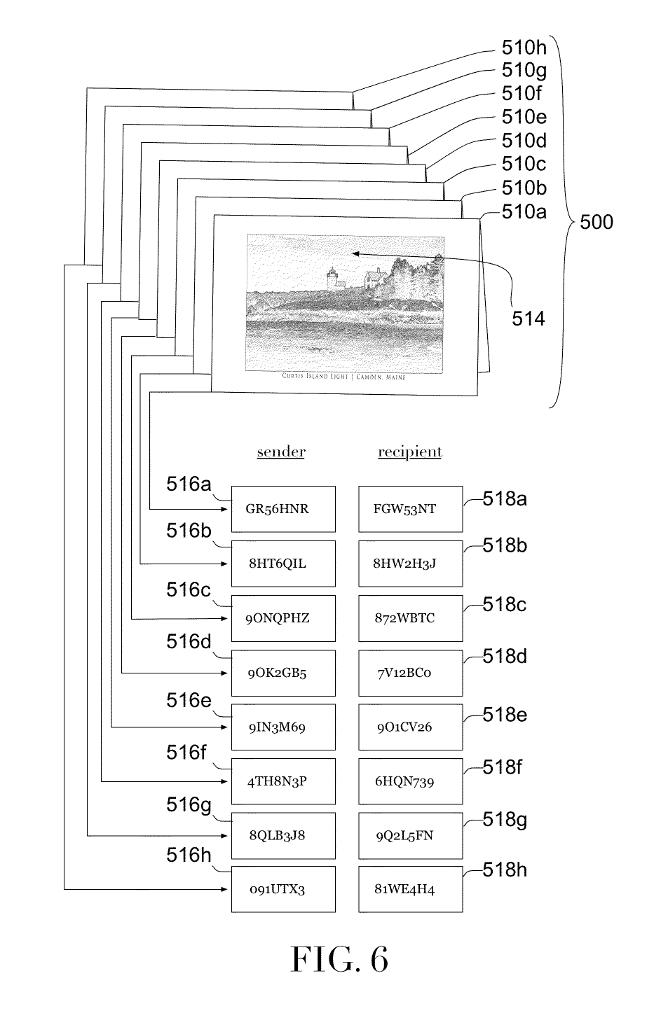

A plurality of tangible items, each of which has an image and at least one identifier associated with it, can be made as an embodiment. FIG. 6 is a schematic illustration of a plurality of greeting cards 500 made as an embodiment, each of which has an image 514, a first identifier and a second identifier associated with it. In the illustrated embodiment, each greeting card 510a, 510b, 510c, 510d, 510e, 510f, 510g, 510h has the same image 514 associated with it. That is, the plurality of greeting cards 500 has a common image 514 such that each greeting card 510a, 510b, 510c, 510d, 510e, 510f, 510g, 510h of the plurality of greeting cards 500 has the same image 514 associated with it. In the illustrated embodiment, each greeting card 510a, 510b, 510c, 510d, 510e, 510f, 510g, 510h has a unique first identifier 516a, 516b, 516c, 516d, 516e, 516f, 516g, 516h associated with it, as compared to all other first 516a, 516b, 516c, 516d, 516e, 516f, 516g, 516h and second 518a, 518b, 518c, 518d, 518e, 518f, 518g, 518h identifiers associated with the greeting cards 510a, 510b, 510c, 510d, 510e, 510f, 510g, 510h that make the plurality of greeting cards 500. Similarly, in the illustrated embodiment, each greeting card 510a, 510b, 510c, 510d, 510e, 510f, 510g, 510h has a unique second identifier 518a, 518b, 518c, 518d, 518e, 518f, 518g, 518h associated with it, as compared to all other first 516a, 516b, 516c, 516d, 516e, 516f, 516g, 516h and second 518a, 518b, 518c, 518d, 518e, 518f, 518g, 518h identifiers associated with the greeting cards 510a, 510b, 510c, 510d, 510e, 510f, 510g, 510h that make the plurality of greeting cards 500. In FIG. 6, the first 516a, 516b, 516c, 516d, 516e, 516f, 516g, 516h and second 518a, 518b, 518c, 518d, 518e, 518f, 518g, 518h identifiers are highlighted away from their respective greeting cards 510a, 510b, 510c, 510d, 510e, 510f, 510g, 510h for illustration purposes. Also, as illustrated in FIG. 6, each of the first identifiers 516a, 516b, 516c, 516d, 516e, 516f, 516g, 516h can be designated as an identifier to be used by a sender of the respective greeting card 510a, 510b, 510c, 510d, 510e, 510f, 510g, 510h and each of the second identifiers 518a, 518b, 518c, 518d, 518e, 518f, 518g, 518h can be designated as an identifier to be used by a recipient of the respective greeting card 510a, 510b, 510c, 510d, 510e, 510f, 510g, 510h.

In alternative embodiments, each tangible item of a plurality of tangible items made as an embodiment has only a single identifier associated with it, which can be unique as compared to all other identifiers associated with the tangible items that make the plurality of tangible items. In alternative embodiments, two or more of the tangible items that make a plurality of tangible items made as an embodiment have different images associated with them. In a plurality of items made as an embodiment, an identifier can be obscured.

A plurality of items made as an embodiment can be used to provide a plurality of items to an intervening holder, such as a retailer, for ultimate transfer to a user. For example, a publisher of greeting cards can make a plurality of greeting cards according to an embodiment and transfer the plurality of greeting cards to a retailer, such as by selling the plurality of greeting cards as a wholesale lot to the retailer. The retailer can sell individual greeting cards of the plurality of greeting cards to users as retail items, each of which becomes a holder of an individual greeting card of the plurality of greeting cards after a retail sale is completed. As such, a plurality of items made as an embodiment is useful in the various methods described and illustrated herein.

FIG. 7 is a flowchart illustration of a method 600 for granting access to electronic versions of an image associated with a tangible item. A first step 602 comprises selecting an image for association with tangible items of a plurality of tangible items. A performer of the method 600 can perform this step in any suitable manner, including by selecting a photograph, design, logo, or other image from a plurality of images based on quality, appeal, legal rights, such as ownership or license status, or another quality or qualities.

A second step 604 comprises producing a plurality of tangible items such that each tangible item of the plurality of tangible items has an image associated with it and a unique identifier associated with it. The identifier can be unique among all identifiers used in the producing of the plurality of tangible items, unique among all identifiers used by a performer of the method in his or her making of pluralities of tangible items as embodiments, or unique among another set of tangible items or set of pluralities of tangible items. A performer of the method 600 can perform this step by producing a plurality of tangible items, each of which is made as an embodiment, including the various embodiments described and illustrated herein. Also, a performer of the method 600 can perform this step by instructing another party to produce a plurality of tangible items, each as an embodiment, such as in a contract production or contract manufacturing arrangement.

A third step 606 comprises transferring a tangible item of the plurality of tangible items to a user, who becomes a holder of the tangible item. A performer of the method 600 can perform this step in any suitable manner of transferring a tangible item from the performer to a user, such as by physically handing the tangible item to the user, by giving the tangible item to the user as a gift, by selling the tangible item to the user, and by any other manner. Furthermore, a performer can perform this step by transferring the tangible item to one or more intervening holders of the tangible item, who ultimately transfers the tangible item to the user. For example, a performer of the method can transfer the plurality of tangible items produced in step 604 to a retailer, such as by selling the plurality of tangible items at a wholesale cost or on consignment terms, who ultimately transfers the individual tangible item to the user.

A fourth step 608 comprises accepting an identifier associated with a tangible item of the plurality of tangible items from the user. A performer of the method 600 can perform this step in any suitable manner of accepting an identifier from a user, such as by accepting a tangible item that includes the identifier from the user, accepting a report of the identifier from the user, such as an oral report over a telephone connection or internet audio connection, or accepting textual or other input representing the identifier from the user, such as via a computer form. In some embodiments, a performer operates a computer component of a system according to an embodiment that includes software adapted to accept textual input representing the identifier from the user via a form served by the computer or a connected computer by software configured to serve a web page that contains the form, such as Apache or NGINX web server software.

A fifth step 610 comprises retrieving information relating to the tangible item of the plurality of tangible items and to the image from a data store based on the identifier accepted from the user in step 608. A performer of the method 600 can perform this step in any suitable manner, such as by preparing and submitting a query to database server software configured to retrieve the information from the data store. In some embodiments, a performer operates a computer component of a system according to an embodiment that includes software adapted to transform textual input representing the identifier, such as textual input accepted in step 608, into an appropriate query. In some embodiments, information identifying revenue-earning parties for the tangible item of the plurality of tangible items is retrieved. For example, identifying information relating to the retailer who sold the original tangible item to an earlier holder of the tangible item or to the person from whom the identifier was accepted in step 608, an artist who created the image associated with the tangible item of the plurality of tangible items, a brand-owner who provided the tangible item to the person from whom the identifier was accepted in step 608, a charity who has provided the tangible item to the person from whom the identifier was accepted in step 608, another party involved in the presentation of the tangible item to the person from whom the identifier was accepted in step 608, or to any other party can be retrieved.

A sixth step 612 comprises presenting one or more electronic versions of the image to the user. A performer of the method 600 can perform this step in any suitable manner, such as by presenting an electronic storage device, such as a solid state memory drive, on which the electronic versions of the image have been stored, to the user. In some embodiments, a performer operates a computer component of a system according to an embodiment that includes software adapted to prepare one or more web pages based on the information retrieved in step 610 and that includes software adapted to serve the one or more web pages to the user. In some embodiments, the one or more web pages include one or more links that can be clicked by the user with a conventional mouse to initiate downloads of the one or more electronic versions of the image. In other embodiments, the one or more web pages include one or more buttons that can be clicked by the user with a conventional mouse to initiate a transfer of the one or more electronic versions of the image to a particular social networking website via an action adapted to interact with an application programming interface of the social networking website.

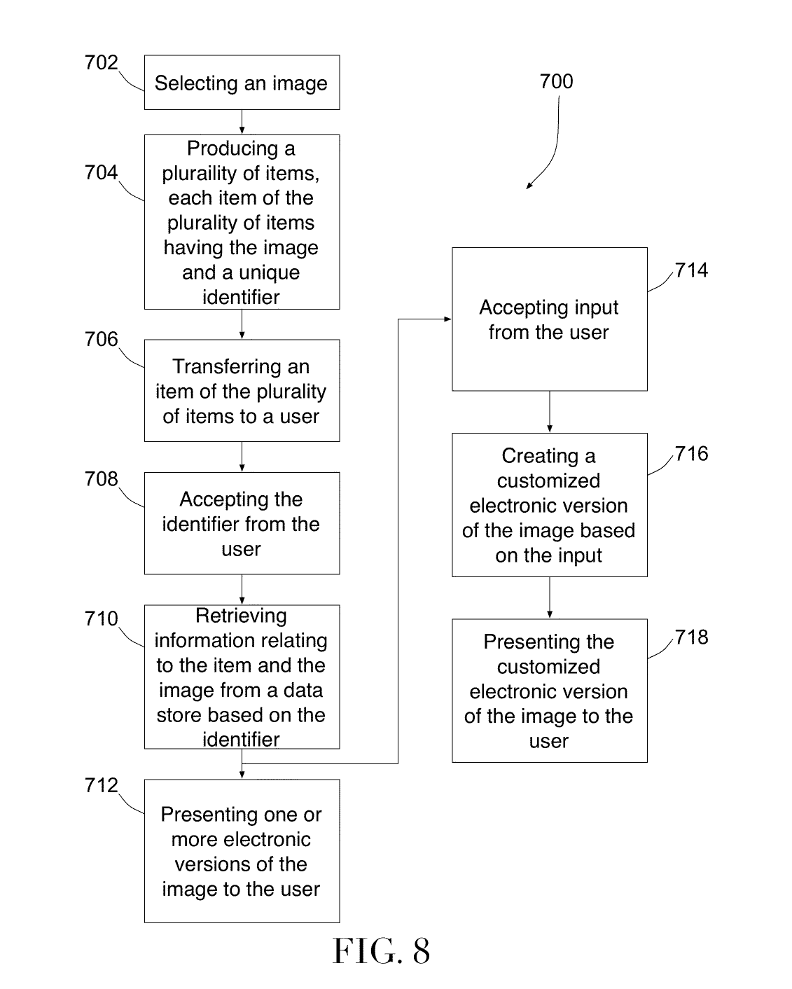

FIG. 8 is a flowchart illustration of a method 700 for granting access to electronic versions of an image associated with a tangible item. The method 700 is similar to the method 600 described above and illustrated in FIG. 7, except as described below. Thus, a first step 702 comprises selecting an image for association with tangible items of a plurality of tangible items. A second step 704 comprises producing a plurality of tangible items such that each tangible item of the plurality of tangible items has an image associated with it and a unique identifier associated with it. A third step 706 comprises transferring a tangible item of the plurality of tangible items to a user, who becomes a holder of the tangible item. A fourth step 708 comprises accepting an identifier associated with a tangible item of the plurality of tangible items from the user. A fifth step 710 comprises retrieving information relating to the tangible item of the plurality of tangible items and to the image from a data store based on the identifier accepted from the user in step 708. A sixth step 712 comprises presenting one or more electronic versions of the image to the user.

Another step 714 comprises accepting input from the user. Any suitable input can be accepted, including textual input, graphical input, multimedia input, such as video input and/or audio input, and any other suitable input. A performer of the method 700 can perform this step in any suitable manner of accepting input from a user, such as by accepting a tangible item that includes the input from the user, accepting a report of the input from the user, such as an oral report over a telephone connection or internet audio connection, or accepting textual or other input from the user, such as via a computer form. In some embodiments, a performer operates a computer component of a system according to an embodiment that includes software adapted to accept textual input as the input from the user via a form served by the computer or a connected computer by software configured to serve a web page that contains the form, such as Apache or NGINX web server software.

Another step 716 comprises creating a customized electronic version of the image based on the input. A performer of the method can perform this step in any suitable manner appropriate for the input. For example, a performer of the method 700 can operate a computer having software adapted to add textual input accepted from the user to an electronic version of the image to create the customized version.

Another step 718 comprises presenting the customized electronic version of the image to the user. The customized electronic version of the image can be presented to the user as part of performance of step 712, in place of step 712, or in addition to step 712.

Steps 714, 716, and 718 can be performed at any suitable point during performance of the method 700, including after completion of step 710, as illustrated in FIG. 8. Other suitable points during performance of the method include before performance of step 708, during performance of step 708, after performance of step 708, before performance of step 710, during performance of step 710, and at any other suitable point during performance of the method 700.

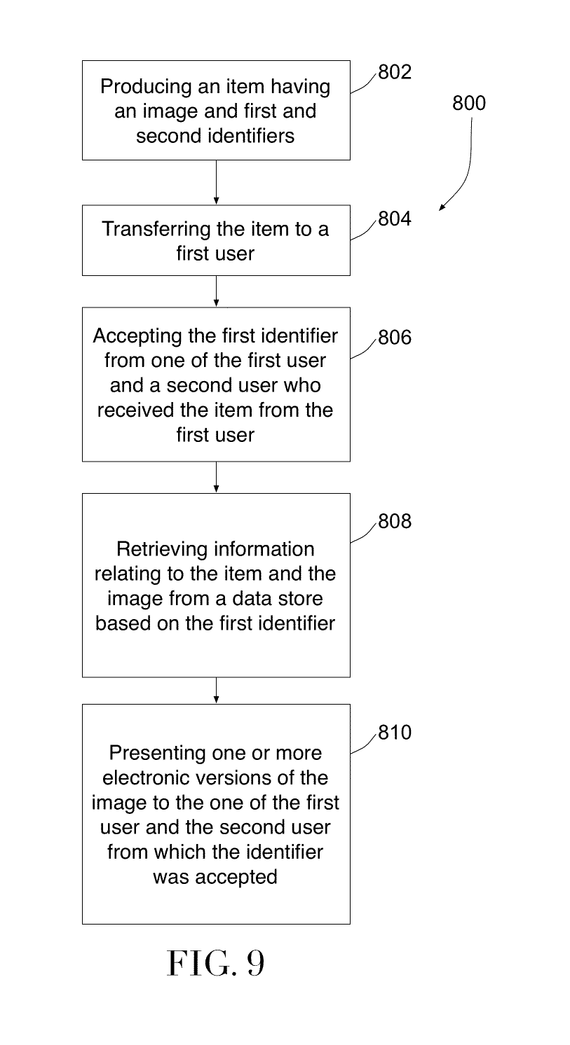

FIG. 9 is a flowchart illustration of a method 800 for granting access to electronic versions of an image associated with a tangible item. A first step 802 comprises producing a tangible item having an image associated with it and first and second identifiers associated with it. A second step 804 comprises transferring the tangible item to a first user, who becomes a holder of the tangible item. A third step 806 comprises accepting the first identifier from one of the first user and a second user who received the tangible item from the first user. A fourth step 808 comprises retrieving information relating to the tangible item and to the image from a data store based on the identifier accepted from the user in step 806. Alternatively, a fourth step can comprise retrieving information relating to the image from a data store based on the identifier accepted from the user in step 806. A fifth step 810 comprises presenting one or more electronic versions of the image to the user from whom the identifier was accepted in step 806.

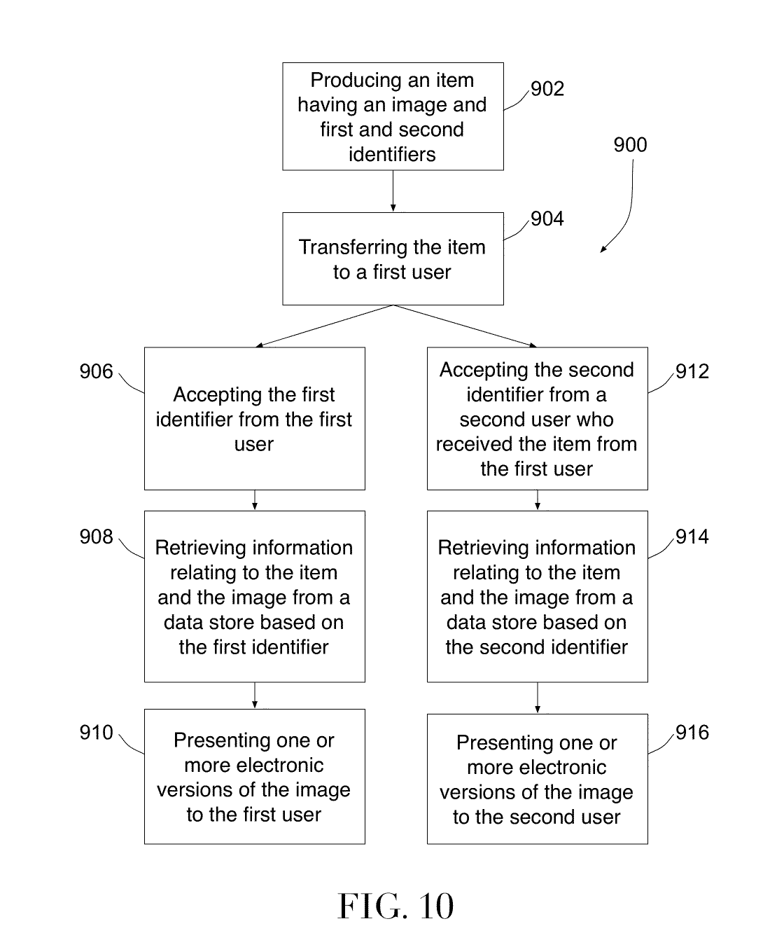

FIG. 10 is a flowchart illustration of a method 900 for granting access to electronic versions of an image associated with a tangible item. A first step 902 comprises producing a tangible item having an image associated with it and first and second identifiers associated with it. A second step 904 comprises transferring the tangible item to a first user, who becomes a holder of the tangible item. Another step 906 comprises accepting the first identifier from the first user. Another step 908 comprises retrieving information relating to the tangible item and to the image from a data store based on the identifier accepted from the user in step 906. Alternatively, step 908 can comprise retrieving information relating to the image from a data store based on the identifier accepted from the user in step 906. Another step 910 comprises presenting one or more electronic versions of the image to the user from whom the identifier was accepted in step 906. Another step 912 comprises accepting the second identifier from a second user who received the tangible item from the first user. Another step 914 comprises retrieving information relating to the tangible item and to the image from a data store based on the identifier accepted from the second user in step 912. Alternatively, step 914 can comprise retrieving information relating to the image from a data store based on the identifier accepted from the user in step 912. Another step 916 comprises presenting one or more electronic versions of the image to the second user from whom the identifier was accepted in step 912.

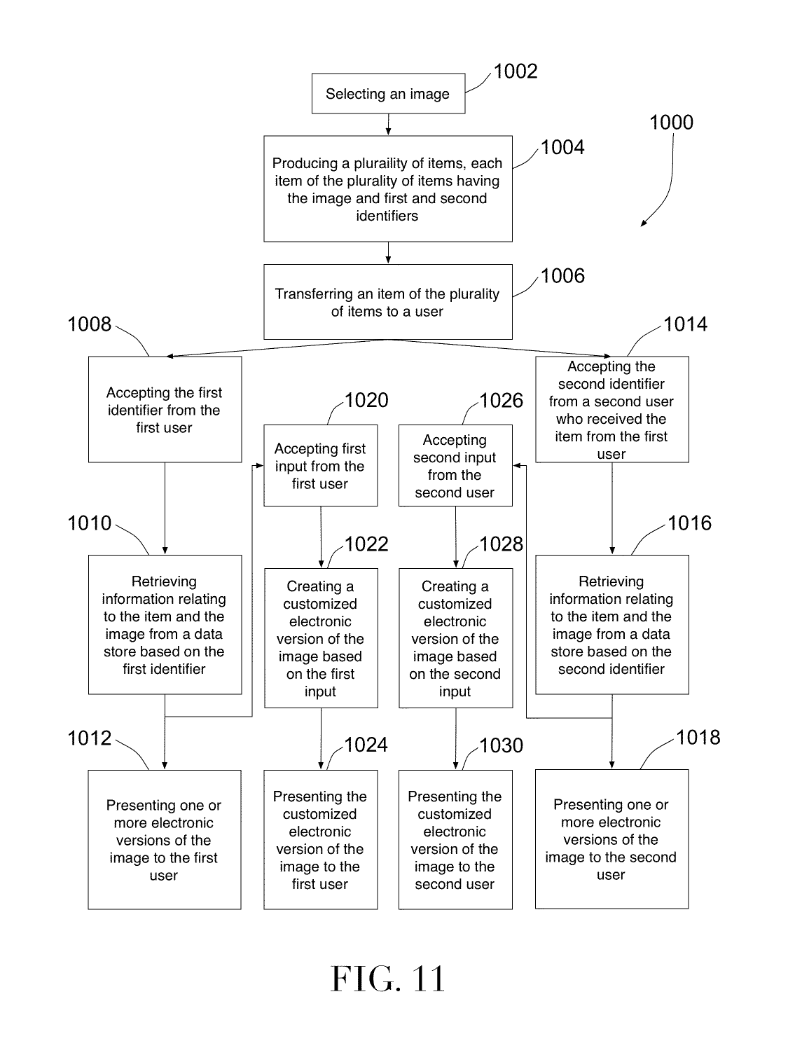

FIG. 11 is a flowchart illustration of a method 1000 for granting access to electronic versions of an image associated with a tangible item. A first step 1002 comprises selecting an image. A second step 1004 comprises producing a plurality of tangible items, each tangible item of the plurality of tangible items having an image associated with it and first and second identifiers associated with it. A third step 1006 comprises transferring a tangible item of the plurality of tangible items to a first user, who becomes a holder of the tangible item. Another step 1008 comprises accepting the first identifier from the first user. Another step 1010 comprises retrieving information relating to the tangible item and to the image from a data store based on the identifier accepted from the first user in step 1008. Alternatively, step 1010 can comprise retrieving information relating to the image from a data store based on the identifier accepted from the first user in step 1008. Another step 1012 comprises presenting one or more electronic versions of the image to the first user. Another step 1014 comprises accepting the second identifier from a second user who received the tangible item of the plurality of tangible items from the first user. Another step 1016 comprises retrieving information relating to the tangible item and to the image from a data store based on the identifier accepted from the second user in step 1014. Alternatively, step 1016 can comprise retrieving information relating to the image from a data store based on the identifier accepted from the user in step 1014. Another step 1018 comprises presenting one or more electronic versions of the image to the second user.

An optional step 1020 comprises accepting input from the first user. Any suitable input can be accepted, including textual input, graphical input, multimedia input, such as video input and/or audio input, and any other suitable input. An optional step 1022 comprises creating a customized electronic version of the image based on the input. An optional step 1024 comprises presenting the customized electronic version of the image to the first user. If this step is performed, the customized electronic version of the image can be presented to the first user as part of performance of step 1012, in place of step 1012, or in addition to step 1012.

An optional step 1026 comprises accepting input from the second user. Any suitable input can be accepted, including textual input, graphical input, multimedia input, such as video input and/or audio input, and any other suitable input. An optional step 1028 comprises creating a customized electronic version of the image based on the input. An optional step 1030 comprises presenting the customized electronic version of the image to the second user. If this step is performed, the customized electronic version of the image can be presented to the second user as part of performance of step 1018, in place of step 1018, or in addition to step 1018.

Steps 1020, 1022, 1024, 1026, 1028, and 1030 can be performed at any suitable point during performance of the method 1000, including after completion of step 1010 for steps 1020, 1022, and 1024 and after completion of step 1016 for steps 1026, 1028, and 1030, as illustrated in FIG. 11. Other suitable points during performance of the method 1000 for steps 1020, 1022, and 1024 include before performance of step 1008, during performance of step 1008, after performance of step 1008, before performance of step 1010, during performance of step 1010, and at any other suitable point during performance of the method 1000. Other suitable points during performance of the method 1000 for steps 1026, 1028, and 1030 include before performance of step 1014, during performance of step 1014, after performance of step 1014, before performance of step 1016, during performance of step 1016, and at any other suitable point during performance of the method 1000.

I claim:

1. A plurality of greeting cards, each greeting card of the plurality of greeting cards comprising:
a substrate;
an image associated with the substrate; and
an identifier associated with the substrate, the identifier representing a key in a data record of a remote data store that can be submitted by a holder of the greeting card to a computer system adapted to retrieve information relating to an electronic version of the image from the data store and transmit the information to the holder of the greeting card;
wherein each greeting card of the plurality of greeting cards has the same image associated with the substrate.

2. The plurality of greeting cards of claim 1, wherein the identifier associated with the substrate of each greeting card in the plurality of greeting cards is unique among all identifiers in the plurality of greeting cards.

3. The plurality of greeting cards of claim 1, wherein the identifier associated with the substrate of each greeting card is obstructed.

4. The plurality of greeting cards of claim 3, wherein each greeting card of the plurality of greeting cards further comprises a removable covering disposed on the identifier.

5. The plurality of greeting cards of claim 4, wherein the removable covering comprises a scratch-off coating.

6. The plurality of greeting cards of claim 4, wherein the removable covering comprises a label.

7. The plurality of greeting card of claim 1, wherein the substrate of each greeting card comprises first and second opposing sides; and
wherein the image associated with the substrate of each greeting card is associated with the first side of the substrate and the identifier is associated with the second side of the substrate.

8. The plurality of greeting card of claim 1, wherein the substrate of each greeting card comprises first and second opposing sides; and
wherein the image associated with the substrate of each greeting card is associated with the first side of the substrate and the identifier is associated with the first side of the substrate.

9. The plurality of greeting cards of claim 8, wherein the substrate of each greeting card comprises a fold;
wherein the first side of the substrate of each greeting card comprises first and second portions separated by the fold; and
wherein the second side comprises third and fourth portions separated by the fold.

10. The plurality of greeting cards of claim 9, wherein the image of each greeting card and the identifier of each greeting card is associated with the first side of the greeting card.

11. The tangible item of claim 10, wherein the image of each greeting card is associated with the first portion and the identifier of each greeting card is associated with the second portion.

12. The plurality of greeting cards of claim 9, wherein the image of each greeting card is associated with the first side of the greeting card and the identifier of each greeting card is associated with the second side of the greeting card.

13. The plurality of greeting cards of claim 1, wherein each greeting card of the plurality of greeting cards further comprises a second identifier associated with the substrate, the identifier representing a key in a data record of a remote data store that can be submitted by a holder of the greeting card to a computer system adapted to retrieve information relating to an electronic version of the image from the data store and transmit the information to the holder of the greeting card.

14. The plurality of greeting cards of claim 13, wherein the second identifier associated with the substrate of each greeting card in the plurality of greeting cards is unique among all identifiers in the plurality of greeting cards.

15. The plurality of greeting cards of claim 13, wherein each greeting card of the plurality of greeting cards further comprises a removable covering disposed on one of the identifier and the second identifier.

16. The plurality of greeting cards of claim 15, wherein the removable covering comprises a scratch-off coating.

17. The plurality of greeting cards of claim 15, wherein the removable covering comprises a label.

18. The plurality of greeting cards of claim 13, wherein each greeting card of the plurality of greeting cards further comprises a removable covering disposed on each of the identifier and the second identifier.

19. A greeting card system, comprising:
a plurality of greeting cards, each greeting card of the plurality of greeting cards comprising a substrate, a common image associated with the substrate, and an identifier associated with the substrate;
a data store containing information about the common image; and
a computer adapted to retrieve the information from the data store using an identifier associated with the substrate of a greeting card of the plurality of greeting cards and adapted to present electronic versions of the common image to a holder of the greeting card.

20. A method of granting access to electronic versions of an image, comprising:
selecting an image for association with a plurality of greeting cards;
producing a plurality of greeting cards, each greeting card of the plurality of greeting cards comprising a substrate having the image associated with the substrate and an identifier associated with the substrate;
transferring the plurality of greeting cards to a retailer;
accepting an identifier associated with the substrate of a greeting card of the plurality of greeting cards from a user who received the greeting card from the retailer;
retrieving information relating to the image from a data store based on the identifier; and
presenting one or more electronic versions of the image to the user for the user's personal use.
